(19) United States
(12) Patent Application Publication
(10) Pub. No.: US 2022/0220006 A1
(43) Pub. Date: Jul. 14, 2022

(54) DEVICE FOR CONTINUOUS SEAWATER DESALINATION AND METHOD THEREOF

(71) Applicant: Xiamen University, Xiamen (CN)

(72) Inventors: Xu HOU, Xiamen (CN); Xinwen XIE, Xiamen (CN); Miao WANG, Xiamen (CN); Wenyan DENG, Xiamen (CN); Hui XIONG, Xiamen (CN); Wen HE, Xiamen (CN)

(21) Appl. No.: 17/706,538

(22) Filed: Mar. 28, 2022

Related U.S. Application Data
(63) Continuation of application No. PCT/CN2020/115368, filed on Sep. 15, 2020.

(30) Foreign Application Priority Data
Sep. 27, 2019 (CN) 201910926145.7

(51) Int. Cl. C02F 1/14; B01D 69/12; B01D 71/02; B01D 69/02; B01D 61/36; C02F 1/44

(52) U.S. Cl. CPC C02F 1/14; B01D 69/12; B01D 71/021; B01D 69/02; C02F 2103/08; B01D 61/368; C02F 1/448; B01D 61/362; B01D 61/366

(57) ABSTRACT

A device for continuous seawater desalination of and a method thereof. A hydrophobic carbon nanotube composite membrane is made of a hydrophobic polymer and carbon-based materials, and the carbon-based materials are, such as, carbon nanotubes or graphene. The hydrophobic carbon nanotube composite membrane is perforated to obtain the hydrophobic carbon nanotube composite membrane having micrometer-nanometer multi-level pore structure using laser light. Further, a surface is coated with a photothermal-electrothermal responsive polymer to increase electric joule heat and photothermal effects to increase energy utilization efficiencies, and the hydrophobic carbon nanotube composite membrane having multi-level pore structure and electrothermal effects and photothermal effects is finally obtained. A device is designed, a hydrophobic carbon nanotube composite porous membrane is applied to electro-induced and light-induced seawater desalination, and conditions are controlled to enable the hydrophobic carbon nanotube composite porous membrane to generate heat.

### RELATED APPLICATIONS

This application is a continuation of and claims priority to International patent application number PCT/CN2020/115368, filed Sep. 15, 2020, which claims priority to Chinese patent application number 201910926145.7, filed on Sep. 27, 2019. International patent application number PCT/CN2020/115368 and Chinese patent application number 201910926145.7 are incorporated herein by reference.

### FIELD OF THE DISCLOSURE

The present disclosure relates to a novel energy-saving seawater desalination method, the method is based on highly effective photothermal conversion efficiency and Joule heating effects of carbon-based materials, such as carbon nanotubes or graphene, and the method combines thermal phase change and evaporation mass transmission to achieve seawater desalination.

### BACKGROUND OF THE DISCLOSURE

With population growth and water pollution becoming more and more serious, water shortages have become one of the most severe global challenges for humans and society. At present, seawater desalination technologies that have been developed and have been widely used in large-scale commercial applications comprise reverse osmosis (RO), electrodialysis (ED), multi-stage flash (MSF), low-temperature multi-effect (MED), etc. These technologies are highly effective in desalination. At the same time, the energy consumption caused by equipment operation cannot be ignored, and solar seawater desalination technology is considered to be a promising technology due to its advantages of low energy consumption, low cost, high energy conversion efficiency, and environmental friendliness. At present, the field of solar seawater desalination has achieved interface solar-driven steam generation through photon management, nano-scale thermal control, development of new photothermal conversion materials, and design of high-efficiency light-absorbing solar distillers. This green and sustainable seawater desalination technology has become a research hotspot in recent years. Carbon-based materials such as carbon nanotubes, graphene, carbon black, graphite, etc. have light absorption capabilities covering the entire solar spectrum and are a new type of light-to-heat conversion material.

For embodiment, CN200910169726.7 provides a method of using carbon nanotubes to absorb solar energy and efficiently desalinate seawater using carbon nanotubes to realize the conversion of light energy to heat energy and using circulating carrier gas to take away and transfer the heat energy on the surface of carbon nanotubes to seawater. The carrier gas enters the seawater storage tank to divide the seawater into upper and lower layers with different temperatures and concentrations. The upper and lower layers of seawater and the carrier gas have a continuous heat, mass, and momentum transfer process to realize the separation of fresh water and concentrated seawater. CN201710591777.3 discloses a solar seawater desalination or sewage treatment method based on a carbon nanotube membrane. This disclosure uses a carbon nanotube vertical array directly prepared by a chemical vapor deposition method as a raw material, and obtains a carbon nanotube vertical array membrane with strong light absorption and surface hydrophilicity. This hydrophilic carbon nanotube membrane is placed on a surface of the water to be treated. As the carbon nanotube membrane can efficiently absorb light and perform light-to-heat conversion, heating the water body causes rapid evaporation of water, and the steam is condensed to obtain purified water.

However, the solar desalination process is affected by the intensity of sunlight. The four seasons and geographical limitations related to the intensity of sunlight make traditional solar desalination processes unable to achieve continuous and efficient desalination under natural conditions.

CN201810956984.9 provides a carbon nanotube-cellulose acetate membrane for high-efficiency desalination of seawater and a preparation method thereof. This method introduces magnetized carbon nanotubes into the cellulose acetate reverse osmosis membrane, and aligns the carbon nanotubes through a magnetic field to form a permeation channel. When in use, a high-frequency pulsed magnetic field is applied to make the carbon nanotubes micro-oscillate to weaken the interaction of water molecules and cellulose acetate and promote the passage of water molecules through the membrane. Compared with the traditional method, the carbon nanotube-cellulose acetate membrane prepared by the disclosure can still maintain a higher desalination rate and water flux after long-term use and has high seawater desalination efficiency and long service life.

However, it still has not solved the technical problem of continuous desalination of seawater.

### BRIEF SUMMARY OF THE DISCLOSURE

The present disclosure provides an electrothermal-photothermal alternative continuous seawater desalination system based on Joule heating effects and photothermal conversion effects of carbon-based materials, such as, carbon nanotubes or graphene. The system can store some solar energy in a form of electric energy during daylight. At the same time, a carbon nanotube composite porous membrane can directly absorb solar energy, and a photothermal conversion is complete. This heat promotes water molecules evaporate and pass through micrometer-nanometer multi-level pores of the carbon nanotube composite porous membrane. Evaporated water molecules are collected, and a first solar seawater desalination is finally achieved. The system can release electric energy when there are insufficient daylight hours or at night, and the carbon nanotube composite porous membrane generate Joule heat due to the electric energy. The Joule heat drives the water molecules evaporate and pass through the micrometer-nanometer multi-level pores. Evaporated water molecules is collected, and a second solar seawater desalination is finally achieved. The system achieves a highly effective and energy-saving seawater desalination process and solves the common technical problems, such as, corrosion resistance and fouling resistance of membrane materials. It utilizes the excellent conductivity, light absorption characteristics, and anti-fouling and salt-resistance effects of carbon-based composite membranes, and, combined with solar cells, the system realizes 24 hour continuous seawater desalination.

1. In this method, carbon nanotubes are used as carbon-based materials, which have light absorption capacity covering entire sunlight spectrum and excellent photothermal conversion characteristics. This type of material shows strong Joule heat effects and electrochemical corrosive resistance under energized conditions. A multi-level and multi-scale pore channel system in this kind of material can continuously and efficiently provide structural support for water transport and salt blocking. It is a new type of photothermal and electrothermal dual-responsive seawater desalination membrane material.

2. This method uses a laser perforating method to construct a micrometer-nanometer multi-level pore structure, which has both high salt rejection rate and quick water transport capabilities.

3. The hydrophobic polymer is used as the structural support when the method is implemented, and the carbon-based composite membrane has good mechanical strength (no deformation happens after immersing in salt water for 30 minutes).

4. When this method is implemented, the carbon nanotubes, graphene, or other carbon-based materials can still maintain good hydrophobicity under long-term energized conditions (after 1.5 hours of electrification, a contact angle of 100 g/L NaCl solution on the membrane surface can still be maintained above 120° C.), which breaks through membrane wetting barriers of the traditional commercial separation membranes in practical applications.

5. When this method is implemented, an interdigital electrode is connected to the carbon nanotube composite porous membrane used in parallel to ensure that each membrane can reach a highest temperature under the same voltage.

6. When this method is implemented, a sandwich structure (i.e., a sandwich package structure) is used to package the carbon nanotube composite porous membrane and the electrode. That is, a first polymethyl methacrylate (PMMA) plate, a first silica gel, the carbon nanotube composite porous membrane and the electrode, a second silica gel, a second PMMA plate are superimposed in sequence, and the sandwich structure can effectively reduce the electrochemical corrosion of materials of the carbon nanotube composite porous membrane and the electrode and avoid circuit aging.

7. When this method is implemented, compared with the traditional commercial separation membranes, the carbon nanotube composite porous membrane can generate heat, and a heating temperature is controllable (a temperature of the membrane surface can be adjusted by adjusting the voltage, and the temperature of the membrane surface can be up to 113.2° C. at 20 V).

8. When this method is implemented, an electrical responsive polymer can be coated on a surface of the carbon nanotube composite porous membrane to reduce an operation voltage of the system and reduce electrochemical reactions on a surface of the electrode. After a carbolong complex 1# is coated, the surface of the membrane can be up to 150° C. under 4 V voltage.

9. When this method is implemented, higher evaporation rate is achieved than the traditional solar seawater desalination process (electrothermal evaporation rate: 12.51 kg/m²·h, photothermal evaporation rate: 15.80 kg/m²·h).

10. The method has a better salt rejection rate (up to 99.959%) than the traditional seawater desalination process.

11. When this method is implemented, the energy utilization efficiency is high. When the voltage is 10 V, the energy utilization efficiency of the electric joule heat is the highest under a condition that four membranes are integrated, and its value is 92.70%. When the light concentration Cₒₚₜ=4, the energy utilization efficiency of light heat is the highest under the condition that four membranes are integrated, and its value is 93.64%.

12. This method can be alternately operated for 24 hours uninterruptedly. The carbon nanotube composite porous membrane is converted from light to heat to provide heat and a driving force for mass transmission to carry out the seawater desalination process under daylight conditions, and a solar panel is used to convert light energy into a form of electric energy. The energy stored in the solar panel is used to energize the carbon nanotube composite porous membrane to generate Joule heat to provide heat and a driving force of mass transmission to carry out the seawater desalination process under insufficient daylight conditions or at night. This cycle realizes 24 hour continuous seawater desalination by alternating a photothermal process and an electrothermal process.

13. All energy used in this method is directly or indirectly provided by the sunlight without external energy input systems. It is a new energy-saving seawater desalination method.

14. A hydrophobic carbon nanotube composite membrane is made of a hydrophobic polymer and carbon-based materials, and the carbon-based materials are, such as, carbon nanotubes or graphene. The hydrophobic carbon nanotube composite membrane is perforated to obtain the hydrophobic carbon nanotube composite membrane having micrometer-nanometer multi-level pore structure using laser light. Further, a surface is coated with a photothermal-electrothermal responsive polymer to increase electric joule heat and photothermal effects to increase energy utilization efficiencies, and the hydrophobic carbon nanotube composite membrane having multi-level pore structure and electrothermal effects and photothermal effects is finally obtained. A corresponding device is designed, a hydrophobic carbon nanotube composite porous membrane is applied to electro-induced seawater desalination and light-induced seawater desalination, conditions are controlled to enable the hydrophobic carbon nanotube composite porous membrane to generate heat, the heat functions a heat source to provide the driving force for the mass transmission of the water phase change. The present disclosure combines a thermal phase change process and a method using the membrane, and the 24 hour continuous seawater desalination by alternating a photothermal process and an electrothermal process is complete.

### BRIEF DESCRIPTION OF THE DRAWINGS

The present disclosure will be further described below in combination with the accompanying drawings and embodiments.

FIG. 1 illustrates a diagram of a 24 hour continuous seawater desalination mechanism by alternating Joule heat and light heat.

FIG. 2 illustrates a diagram of a 24 hour continuous seawater desalination device by alternating the Joule heat and the light heat.

FIGS. 3A, 3B, 3C, and 3D illustrate diagrams of connection structures and a package of an electrode. FIG. 3A illustrates a diagram of connection structures of an interdigital electrode; FIG. 3B illustrates a diagram of a polymethyl methacrylate (PMMA) package clip; FIG. 3C illustrates an actual diagram of a sandwich package structure; and FIG. 3D illustrates an equivalent circuit diagram of the interdigital electrode.

FIG. 4 illustrates a diagram of a device for seawater desalination.

FIG. 5 illustrates a contact angle test of carbon nanotube composite porous membranes when the carbon nanotube composite porous membranes are energized.

FIGS. 6A, 6B, 6C, 6D, and 6E illustrate infrared thermal imaging charts. FIG. 6A illustrates an infrared thermal imaging chart of one of the carbon nanotube composite porous membranes under external electric field; FIG. 6B illustrates an infrared thermal imaging chart of the carbon nanotube composite porous membranes coated with carbolong complex 1# under the external electric field; FIG. 6C illustrates an infrared thermal imaging of four of the carbon nanotube composite porous membranes coated with the carbolong complex 1# under the external electric field; FIG. 6D illustrates a temperature of a top cover of the device in an electrothermal seawater desalination process; and FIG. 6E illustrates a temperature of the top cover of the device in a photothermal seawater desalination process.

FIG. 7A illustrates a side surface of a hydrophobic carbon nanotube composite membrane; FIG. 7B illustrates a surface of a hydrophobic carbon nanotube composite membrane; FIG. 7C illustrates a side surface of a carbon nanotube composite hydrophobic porous membrane prepared by perforating the hydrophobic carbon nanotube composite membrane using laser; and FIG. 7D illustrates a surface of the carbon nanotube composite hydrophobic porous membrane prepared by perforating the hydrophobic carbon nanotube composite membrane using the laser.

FIG. 8A illustrates a diagram of the perforating using the laser; and FIG. 8B illustrates a microscope image of the perforating using the laser.

FIGS. 9A, 9B, and 9C illustrate an actual product and effects of the device for the seawater desalination. FIG. 9A illustrates a diagram of desalination effects and the seawater desalination device using the one of the carbon nanotube composite porous membranes under the sunlight intensity of 1 kW/m²; FIG. 9B illustrates a diagram of desalination effects and the seawater desalination device using the one of the carbon nanotube composite porous membranes; and FIG. 9C illustrates a diagram of desalination effects and the seawater desalination device in which four of the carbon nanotube composite porous membranes are integrated.

FIG. 10 illustrates a molecular structure of a responsive polymer.

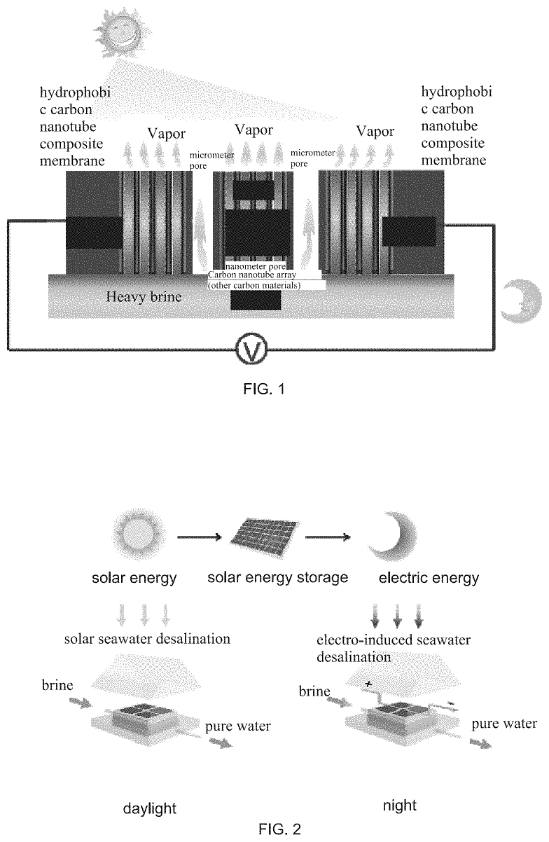

### DETAILED DESCRIPTION OF THE EMBODIMENTS

1. Preparation of a Hydrophobic Carbon Nanotube Composite Membrane (e.g., a Base Using a Carbon Nanotube Array):

Toluene is used as carbon source, ferrocene is used as a catalyst, and 4 wt % solution of ferrocene and toluene is prepared. A carbon nanotube array with a wide tube diameter (about 80 nm), a high crystallinity degree (I_{G/D}=≠2.51), a high density (0.17 g/cm³), and a controllable height (20-1000 μm) is prepared at 740° C. using floating catalyst chemical vapor deposition (FCCVD) method. Polydimethylsiloxane (PDMS) components A and B are uniformly mixed at a weight ratio of 10:1 to obtain a mixture, air bubbles of the mixture are removed for 30 minutes, and the mixture is dripped onto a surface of the carbon nanotube array by a pipette. After the carbon nanotube array is completely infiltrated, the carbon nanotube array is left to stand for 30 minutes, excessive resin of the PDMS components A and B is removed by setting a spin coating procedure as follows: 1) 500 revolutions for 20 seconds, 2) 3000 revolutions for 40 seconds, and 3) the carbon nanotube array is solidified at 70° C. for 3 hours to obtain a membrane. After a complete solidification, a substrate is peeled off, a surface is polished to expose a carbon nanotube end of the membrane, and the membrane is sliced with an ultra-thin microtome to obtain a hydrophobic carbon nanotube composite membrane, as illustrated in FIG. 7A. A thickness of the hydrophobic carbon nanotube composite membrane is controlled to be 30 μm to ensure a high water throughput of a porous membrane.

PDMS components A and B comprise two components: a prepolymer A and a crosslinking agent B. A component of the prepolymer A is mainly poly(dimethyl-methylvinylsiloxane) prepolymer and a trace amount of platinum catalyst. The crosslinking agent B is a prepolymer and a crosslinking agent with a side chain of a vinyl group, for example, poly(dimethyl-methylhydrogensiloxane). The vinyl group is configured to react with a silicon-hydrogen bond to achieve a hydrosilylation reaction to form a three-dimensional net structure by mixing the prepolymer A and the crosslinking agent B. A component ratio of the prepolymer A and the crosslinking agent B is selected to control mechanical properties of PDMS.

2. Perforation of the Hydrophobic Carbon Nanotube Composite Membrane:

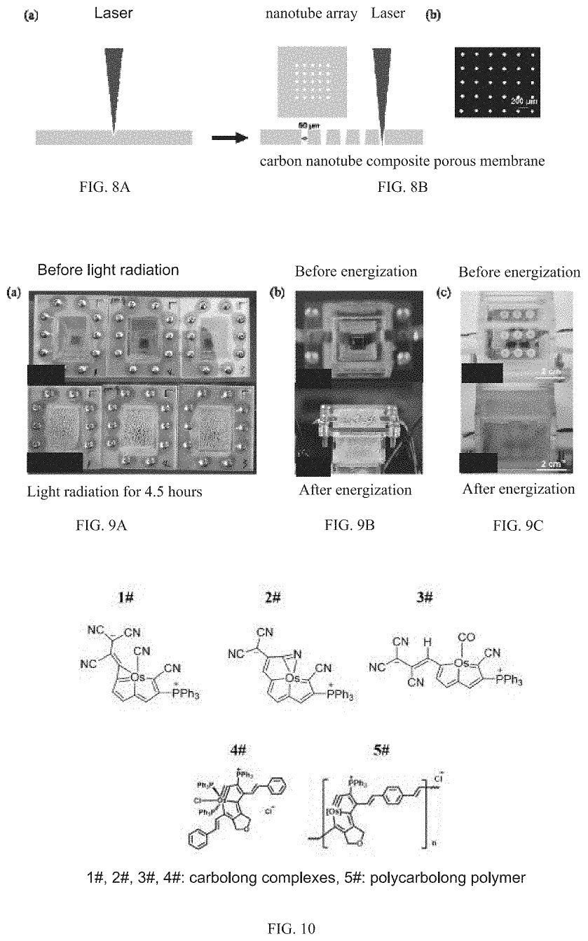

A laser cutting machine is used, a cutting power is 25 W, and a cutting speed is 2 m/s. After the laser cutting machine is focused, carbon nanotube composite porous membranes 5 with a pore size of 50 μm are obtained, as illustrated in FIG. 7B. A density of the carbon nanotube composite porous membranes 5 is 64 holes per 5 mm×5 mm A preparation process and pore size characteristics are illustrated in FIG. 8.

3. A package clip (i.e., a package structure) of the one or more carbon nanotube composite porous membranes and an electrode comprises connection structures of the electrode and package clips.

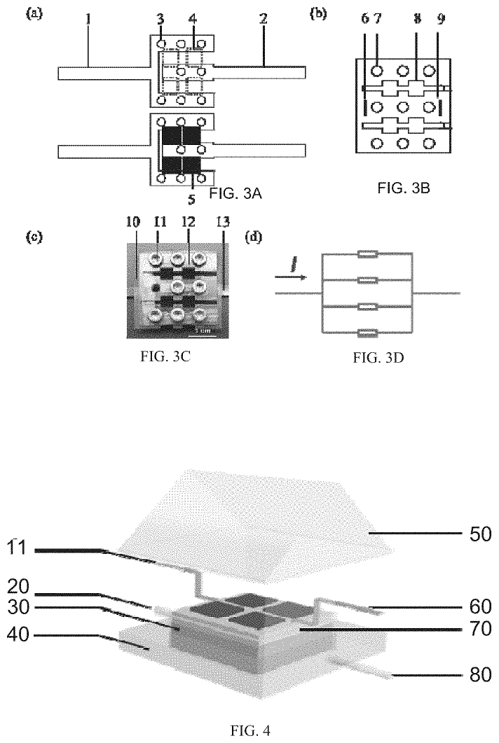

(1) The connection structures of the electrode: a device by which an interdigital electrode is connected to the carbon nanotube composite porous membrane in parallel is illustrated in FIGS. 3A, 3B, 3C, and 3D, and a connection method of the interdigital electrode is illustrated in FIG. 3A. Specifically, FIG. 3A illustrates a positive pole 1 of a titanium electrode, a negative pole 2 of the titanium electrode, a first screw hole 3, a location area 4 of the carbon nanotube composite porous membranes 5, and the carbon nanotube composite porous membranes 5. A conductive silver glue is used to enable upper edges and lower edges of the carbon nanotube composite porous membranes 5 to be tightly attached to upper ends and lower ends of interdigital parts of the positive pole 1 and the negative pole 2 of the titanium electrode, and left edges and right edges of the carbon nanotube composite porous membranes 5 are not attached to the positive pole 1 and the negative pole 2 of the titanium electrode to ensure that a current flowing through the positive pole 1 and the negative pole 2 of the titanium electrode can flow through the carbon nanotube composite porous membranes 5. Four of the carbon nanotube composite porous membranes 5 are bonded in dashed frames in FIG. 3A. An equivalent circuit of the titanium electrode is illustrated in FIG. 3D. The carbon nanotube composite porous membranes 5 does not theoretically shutter the first screw hole 3 (or the first screw groove). In this step, the first screw hole 3 (or the first screw groove) only help each of the carbon nanotube composite porous membranes 5 to be positioned during a carbon bonding process of the carbon nanotube composite porous membranes 5, and channel characteristics of the first screw hole 3 (or the first screw groove) are maintained.

(2) One of polymethyl methacrylate (PMMA) package clips 12 is illustrated in FIG. 3B. The PMMA package clip 12 comprises an electrode socket 6, a second screw hole 7 (or a second screw groove), a carbon membrane groove 8 (or a carbon membrane hole), and the PMMA board 9. A thickness of the PMMA board 9 is 2 mm, and the PMMA board 9 is perforated in shapes illustrated in FIG. 3B at positions corresponding to the electrode socket 6, the second screw hole 7 (the second screw groove), and the carbon membrane groove 8 (the carbon membrane hole), wherein the electrode socket 6 allows the titanium electrode to pass through for introducing the titanium electrode, and the carbon membrane groove 8 (the carbon membrane hole) allows salt water (e.g., seawater) to pass through to contact surfaces of the carbon nanotube composite porous membranes 5.

(3) One of silica gel pad package clips 10 is illustrated in FIG. 3B. A structure of the one of the silica gel pad package clips 10 is the same as the one of the PMMA package clips 12.

(4) A sandwich package structure is illustrated in FIG. 3C. The sandwich package structure comprises the silica gel pad package clips 10, screws 11, the PMMA package clips 12, and connection parts 13 of the titanium electrode.

\textcircled{1} First, referring to the connection parts 13 of the titanium electrode, four of the carbon nanotube composite porous membranes 5 are bond with the positive pole 1 of titanium electrode or the negative pole 2 of titanium electrode by using conductive silver glue and the method described in step (1) to define the connection parts 13 of the titanium electrode in this step, as illustrated in FIG. 3A.

\textcircled{2} Second, referring to FIG. 3C, the silica gel pad package clips 10 in step (3) are used. The connection parts 13 of the titanium electrode in step (1) are sandwiched between two of the silica gel pad package clips 10 to define a first sandwich structure, and a third screw hole (a third screw groove) of the two of the silica gel pad package clips 10 is aligned with the first screw hole 3 of the connection parts 13 of the titanium electrode in step (1). The positive pole 1 of the titanium electrode or the negative pole 2 of the titanium electrode in the connection parts 13 of the titanium electrode respectively extend out of electrode sockets of the two of the silica gel pad package clips 10. After this step is complete, the connection parts 13 of the titanium electrode with the silica gel pad package clips 10 are obtained.

\textcircled{3} Finally, the PMMA package clips 12 in step (2) are used. Referring to FIG. 3C, two of the PMMA package clips 12 in step (2) are used to continually package the connection parts 13 of the titanium electrode with the two of the silica gel pad package clips 10 to define a second sandwich structure, and the positive pole 1 of the titanium electrode or the negative pole 2 of the titanium electrode in the connection parts 13 of the titanium electrode maintained after the package using the two of the silica gel pad package clips 10 in the previous step respectively extend out of the electrode sockets 6 of the two of the PMMA package clips 12.

\textcircled{4} A 5-layer sandwich package structure comprising a first PMMA package clip, a first silica gel pad package clip, the carbon nanotube composite porous membranes 5 and the connection parts of the titanium electrode, a second silica gel pad package clip, and a second PMMA package clip superimposed in sequence is finally obtained. A screw is inserted into corresponding screw grooves, and the connection parts of the titanium electrode are packaged by stress after the screw is tightened.

4. Referring to FIG. 4, the seawater desalination device comprises electrode holes 11 and 60, a heavy brine inlet 20, a heavy brine storage tank 30, a pure water collection tank 40, a top cover 50, floating position 70 for the package structure of the carbon nanotube composite porous membranes 5 and the titanium electrode, and a pure water outlet 8. The top cover 50 is transparent, and the top cover 50 is preferably removable. A structure of the seawater desalination device is as follows. The electrode holes 11 and 60 are respectively located on a left side wall and a right side wall of the seawater desalination device. The heavy brine inlet 2 passes through the left side wall of the seawater desalination device and is connected to the heavy brine storage tank 30 to maintain a heavy brine level in the heavy brine storage tank 30. The floating positions 7 for the package structure of the carbon nanotube composite porous membranes 5 and the titanium electrode are located in the heavy brine storage tank 30 and are used to place the package structure of the carbon nanotube composite porous membranes 5 and the titanium electrode. A size of the floating positions 70 is the same as a size of the heavy brine storage tank 30 for easily clamping the package structure of the carbon nanotube composite porous membranes 5 and the titanium electrode. The pure water collection tank 40 is “ [symbol] ”-shaped (e.g., two squares with a same center or two rectangular frames with a same center) and surrounds the heavy brine storage tank 30. The pure water outlet 80 extends out of the right side wall of the seawater desalination device and is connected to the pure water collection tank 40. When the seawater desalination device works, water vapor is evaporated due to heat, and the water vapor condenses on the top cover 50 of the seawater desalination device and slides into the pure water collection tank 40 alongside walls of the seawater desalination device. A working mode of the seawater desalination device is as follows. The top cover 50 is opened, the package structure of the carbon nanotube composite porous membranes 5 and the titanium electrode is clamped to the floating positions 70, the positive pole 1 or the negative pole 2 of titanium electrode is led out from the electrode holes 11 and 60, and the top cover 50 is closed. The heavy brine is injected from the heavy brine inlet 20 to enable the package structure of the carbon nanotube composite porous membranes 5 and the titanium electrode to be floated in the heavy brine storage tank 30, and hollow parts of the package structure allow the carbon nanotube composite porous membranes 5 to contact the brine. The carbon nanotube composite porous membranes 5 generate the heat, and the heat then enables a phase change of the water. Evaporated water molecules pass through a micrometer-nanometer pore system (i.e., a micrometer-nanometer multi-level pore structure) in the carbon nanotube composite porous membranes 5 to reach an inner surface of the top cover 50. After the evaporated water molecules condense, pure water finally converges in the pure water collection tank 40 along a slope of the inner surface of the top cover 50 and is led out by the pure water outlet 80 to achieve seawater desalination.

5. Referring to FIGS. 2 and 4, a 24 hour continuous seawater desalination is as follows. A system comprises the seawater desalination device and a solar panel. The seawater desalination device is installed by the method in step 4. In this system, the solar panel can store some solar energy under daylight conditions in the form of electrical energy. On the other hand, the carbon nanotube composite porous membranes 5 can directly absorb the solar energy to achieve a photothermal conversion. This heat promotes water molecules to be evaporated and to pass through the micrometer-nanometer pore system of the carbon nanotube composite porous membranes 5 to collect the evaporated water molecules, so that the seawater desalination is finally achieved using the solar energy. The solar panel in the system can release the electric energy stored under the daylight conditions under insufficient daylight hours (e.g., the length of the daylight is below a threshold) or at night. The solar panel is connected to the positive pole 1 or the negative pole 2 of the titanium electrode drawn out from the electrode holes 11 and 60 of the seawater desalination device in step 4, and a surface of the carbon nanotube composite porous membranes 5 generates Joule heat under electric current. The Joule heat can also drive the carbon nanotube composite porous membranes 5 to achieve electro-induced seawater desalination, thereby the 24 hour continuous seawater desalination is achieved.

### Embodiment 1

Step (1), toluene is used as a carbon source, ferrocene is used as a catalyst, and a 4 wt % solution of the ferrocene and the toluene is prepared. Referring to FIGS. 3A, 3B, 3C, and 3D, a carbon nanotube array with a wide tube diameter (about 80 nm), a high crystallinity (I_{G/D}≠2.51), a high density (0.17 g/cm³), and a controllable height (20-1000 μm) is prepared at 740° C. using FCCVD. PDMS components A and B are uniformly mixed at a weight ratio of 10:1 to obtain a mixture, air bubbles of the mixture are removed for 30 minutes, and the mixture is dripped onto a surface of the carbon nanotube array with a pipette. After the carbon nanotube array is completely infiltrated, the carbon nanotube array is left to stand for 30 minutes, and excessive resin of the PDMS components A and B is removed by setting a spin coating procedure as follows: 1) 500 revolutions for 20 seconds, 2) 3000 revolutions for 40 seconds, and 3) the carbon nanotube array is solidified at 70° C. for 3 hours to obtain a membrane. After a complete solidification, a substrate of the membrane is peeled off, a surface of the membrane is polished to expose a carbon tube end of the membrane, and the membrane is sliced with an ultra-thin microtome to obtain a hydrophobic carbon nanotube composite membrane. A top surface and a side surface of an actual product is illustrated in FIG. 7A. A thickness of the hydrophobic carbon nanotube composite membrane is controlled to 30 μm to ensure a high water throughput of a porous membrane.

Step (2), a laser cutting machine is used, a cutting power is 25 W, and a cutting speed is 2 m/s. After the laser cutting machine is focused, carbon nanotube composite porous membranes with a pore size of 50 μm are obtained. A top surface and a side surface of an actual product is illustrated in FIG. 7B. A density of the carbon nanotube composite porous membranes is 64 holes per 5 mm×5 mm A preparation process and corresponding pore size characteristics are illustrated in FIG. 8.

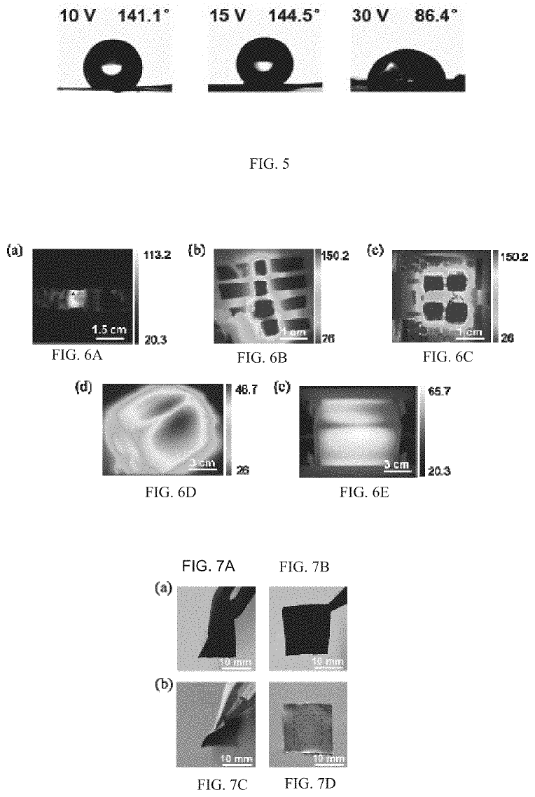

Step (3), the carbon nanotube composite porous membranes prepared in step (2) are used. Two sides of the carbon nanotube composite porous membranes are bonded with titanium foils to define titanium electrodes for an external power supply by using conductive silver glue. Parameters of a direct current power are adjusted to enable the carbon nanotube composite porous membranes to generate Joule heat. A surface temperature of the carbon nanotube composite porous membranes are controlled to be highest under a corresponding voltage and are stabilized, and a voltage of the direct current power is adjusted to be, for example, 10V, 11V, 12V, 13V, 14V, or 15V. When the voltage is 15V, the surface temperature of the carbon nanotube composite porous membranes is highest. Referring to FIG. 6A, a highest temperature reached is 113.2° C.

Step (4), corresponding parameters of the direct current power are set according to data adjusted in step (3). Only one of the carbon nanotube composite porous membranes is clamped in the package structure, and a desalination of heavy brine (100 g/L NaCl) is achieved. The desalination device and desalination effects are illustrated in FIG. 9B. A maximum energy consumption of the seawater desalination process is 1.21×10⁴ J/h, an evaporation energy consumption of water molecules on a surface of the carbon nanotube composite porous membranes is 5.92×10³ J/h, and an energy utilization rate is 48.92%. A maximum desalination rate of the seawater desalination process caused by the Joule heat can reach 99.93% in a single experiment, and a maximum desalination rate is 16.664 kg/m²·h.

### Embodiment 2

Step (1), the carbon nanotube composite porous membranes prepared in Embodiment 1 are used, and two sides of the carbon nanotube composite porous membranes are bonded with titanium foils to define titanium electrodes for an external power supply by using conductive silver glue.

Step (2), a voltage of the direct current power is fixed at 15 V, a time for the voltage of the direct current power applied to the carbon nanotube composite porous membranes is adjusted to be, for example, 5 minutes, 10 minutes, 15 minutes, 20 minutes, 25 minutes, 30 minutes, or 35 minutes. When the voltage is 15V, a surface temperature of the carbon nanotube composite porous membranes is controlled to be highest within a corresponding time and to be stabilized.

Step (3), a voltage value and an energized time of the direct current power are set according to data adjusted in step (2). Only one of the carbon nanotube composite porous membranes is clamped in the package structure, and a desalination of heavy brine (100 g/L NaCl) is achieved. The desalination unit and desalination effects are illustrated in FIG. 9B. When an energized time during the seawater desalination process is respectively 5 minutes, 10 minutes, 15 minutes, 20 minutes, 25 minutes, 30 minutes, or 35 minutes, an evaporation rate is respectively 16.66 kg/m²·h, 9.00 kg/m²·h, 7.00 kg/m²·h, 3.80 kg/m²·h, 3.00 kg/m²·h, 2.50 kg/m²·h, or 1.30 kg/m²·h. A maximum desalination rate of the seawater desalination process caused by the Joule heat can reach 99.93% in a single experiment, and a maximum desalination rate appears within 5 minutes after being energized.

### Embodiment 3

Step (1), 4 mg of powders of photothermal and electrothermal responsive carbolong complexes 1#, 2#, 3#, and 4#, are respectively weighed. The photothermal and electrothermal responsive carbolong complexes 1#, 2#, 3#, and b4# are all osmium-based complexes, and molecular formulas are illustrated in FIG. 10. The photothermal and electrothermal responsive carbolong complexes 1#, 2#, 3#, and 4# are respectively dissolved in 2 mL ethanol and are respectively mixed by sonicating for 10 minutes to obtain solutions of the photothermal and electrothermal responsive carbolong complexes 1#, 2#, 3#, and 4# with a concentration of 2 mg/mL. The carbon nanotube composite porous membranes prepared in Embodiment 1 are used, and an upper surface and a lower surface of the carbon nanotube composite porous membranes are respectively coated with 100 μL of 2 mg/mL of the solutions of the photothermal and electrothermal responsive carbolong complex 1#, 2#, 3#, and 4# (referring to FIG. 10, different carbolong complexes all have photothermal and electrothermal responsive characteristics, but optical-electric responsive characteristics of the different carbolong complexes are different).

Step (2), the titanium electrode is connected to the carbon nanotube composite porous membranes respectively modified with the photothermal and electrothermal responsive carbolong complexes 1#, 2#, 3#, and 4# in step (1). The direct current voltage is continuously incremented at 1V until the direct current voltage reaches 15 V, that is, 1 V, 2 V, 3 V, 4 V, 5 V, 6 V, 7 V, 8 V, 9 V, 10 V, 11 V, 12 V, 13 V, 14 V, and 15 V. When a surface of the carbon nanotube composite porous membranes is stable after being energized, a thermal imaging device is used to characterize a working temperature.

Step (3), a required voltage is tested when the surface of the carbon nanotube composite porous membranes respectively modified with the photothermal and electrothermal responsive carbolong complexes 1#, 2#, 3#, and 4# reaches 150° C. When the surface of the carbon nanotube composite porous membranes modified with the photothermal and electrothermal responsive carbolong complex 1# reaches 150° C., the required voltage is 8V. When the surface of the carbon nanotube composite porous membranes modified with the photothermal and electrothermal responsive carbolong complex 2# reaches 150° C., the required voltage is 12V. When the surface of the carbon nanotube composite porous membranes modified with the photothermal and electrothermal responsive carbolong complex 3# reaches 150° C., the required voltage is more than 15 V. When the surface of the carbon nanotube composite porous membrane modified with the photothermal and electrothermal responsive carbolong complex 4# reaches 150° C., the required voltage is 11V.

### Embodiment 4

Step (1), 4 mg of a powder of the photothermal and electrothermal responsive carbolong complex 1# is weighed. The photothermal and electrothermal responsive carbolong complex 1# is an osmium-based complex, and a molecular formula of the photothermal and electrothermal responsive carbolong complex 1# is illustrated in FIG. 10. The photothermal and electrothermal responsive carbolong complex 1# is dissolved in 2 mL of ethanol and mixed to obtain a solution of the photothermal and electrothermal responsive carbolong complex 1# with a concentration of 2 mg/mL by sonicating for 10 minutes. The upper surface and the lower surface of the carbon nanotube composite porous membranes prepared in Embodiment 1 are coated with 100 μL of the photothermal and electrothermal responsive carbolong complex 1# with the concentration of 2 mg/mL.

Step (2), the carbon nanotube composite porous membrane modified with the photothermal and electrothermal responsive carbolong complex 1# prepared in step (1) is connected to the titanium electrode, and the direct current voltage is continuously incremented at 1V until the direct current voltage reaches 15 V. Four of the carbon nanotube composite porous membranes in which a surface can reach 150° C. under the voltage of 8 V is selected, as illustrated in FIG. 6B.

Step (3), referring to FIG. 3, an interdigital electrode in FIG. 3 is connected to the carbon nanotube composite porous membranes, and a sandwich package structure comprising a first PMMA package clip, a first silica gel pad package clip, the interdigital electrode bonded with the carbon nanotube composite porous membranes, a second silica gel pad package clip, and a second PMMA package clip is used to package the interdigital electrode. After four of the carbon nanotube composite porous membranes are integrated, a pre-energization test is performed to ensure that the four of the carbon nanotube composite porous membranes can be heated to 150° C. at the same time. Referring to FIG. 6C, the sandwich package structure is put into the seawater desalination device in FIG. 4, heavy brine (100 g/L NaCl) is injected into the seawater desalination device, the interdigital electrode is lead out, and a top cover is covered to close the seawater desalination device.

Step (4), two ends of the interdigital electrode are respectively input with 7.5 V, 10 V, 12.5 V, and 15 V of the direct current voltage, energized for 20 minutes, and tested. Desalination rates of the seawater desalination device are respectively 3.33 kg/m²·h, 10.68 kg/m²·H, 11.36 kg/m²·h, and 12.51 kg/m²·h, mass flow rates of the system are respectively 0.33 g/h, 1.07 g/h, 1.14 g/h, or 1.25 g/h, energy utilization efficiencies of the system are respectively 24.14%, 92.70%, 31.22%, or 18.42%. A temperature of a top of the seawater desalination device is the highest when the direct current voltage is 15 V. Referring to FIG. 6D, a highest temperature is 46.7° C. A desalination rate during the test is >99%.

### Embodiment 5

Step (1), 4 mg of powders of the photothermal and electrothermal responsive carbolong complexes 1#, 2#, and 3# are respectively weighed. The photothermal and electrothermal responsive carbolong complexes 1#, 2#, and 3# are all osmium-based complexes, and molecular formulas of the photothermal and electrothermal responsive carbolong complexes 1#, 2#, and 3# are shown in FIG. 10. The photothermal and electrothermal responsive carbolong complexes 1#, 2#, and 3# are respectively dissolved in 2 mL of ethanol and respectively mixed to obtain solutions of the photothermal and electrothermal responsive carbolong complexes 1#, 2#, and 3# with a concentration of 2 mg/mL by sonicating for 10 minutes. The upper surface and the lower surface of the carbon nanotube composite porous membrane prepared in Embodiment 1 are respectively coated with 100 μL of the photothermal and electrothermal responsive carbolong complexes 1#, 2#, and 3# with the concentration of 2 mg/mL (different carbolong complexes in FIG. 10 all have photothermal and electrothermal responsive characteristics, but the optical-electric responsive characteristics of the different carbolong complexes are different).

Step (2), the carbon nanotube composite porous membranes coated with the different carbolong complexes are placed in the seawater desalination device. Referring to FIG. 9A, the seawater desalination device is divided into two chambers. A bottom chamber of the two chambers is a heavy brine (100 g/L of NaCl) storage tank, and a top chamber of the two chambers is a cold condensing chamber and a light-transmitting plate. A bottom of the cold condensing chamber has a “ [symbol] ”-shaped groove used to collect condensed water, and a size of the “ [symbol] ”-shaped groove is the same as the carbon nanotube composite porous membranes for receiving the carbon nanotube composite porous membranes. A test under the sunlight intensity (i.e., natural light) shows that evaporation rates of the carbon nanotube composite porous membranes coated with the different carbolong complexes 1#, 2#, and 3# are respectively 0.88 kg/m²·h, 1.16 kg/m²·h, and 1.40 kg/m²·h, and a highest desalination rate can reach 99.93%.

### Embodiment 6

Step (1), the hydrophobic carbon nanotube composite membrane prepared in step (1) in Embodiment 1 is used. A top surface and a side surface of an actual product are illustrated in FIG. 7A.

Step (2), a laser cutting machine is used to design different pore diameters. A cutting power is set to 25 W, and a cutting speed is set to 2 m/s. After the laser cutting machine is focused, carbon nanotube composite porous membranes with different pore diameters of 50 μm, 75 μm, 100 μm, and 125 μm are respectively obtained. A density is 64 pores per 5 mm×5 mm A preparation process and related pore sizes are illustrated in FIG. 8.

Step (3), the carbon nanotube composite porous membranes with different pore diameters of 50 μm, 75 μm, 100 μm, and 125 μm are respectively placed in the seawater desalination device, and a heavy brine (100 g/L of NaCl) is used in the seawater desalination device. Referring to FIG. 9A, after a test under sunlight, evaporation rates of the carbon nanotube composite porous membranes with different pore diameters of 50 μm, 75 μm, 100 μm, and 125 μm are respectively 1.40 kg/m²·h, 2.14 kg/m²·h, 1.35 kg/m²·h, and 2.39 kg/m²·h. A highest desalination rate can reach 99.93%.

### Embodiment 7

Step (1), 4 mg of a powder of photothermal and electrothermal responsive carbolong complex 3# is weighed. The photothermal and electrothermal responsive carbolong complex 3# is an osmium-based complex, and a molecular formula of the photothermal and electrothermal responsive carbolong complex 3# is illustrated in FIG. 10. The photothermal and electrothermal responsive carbolong complex 3# is dissolved in 2 mL of ethanol and mixed to obtain a solution of the photothermal and electrothermal responsive carbolong complex 3# with a concentration of 2 mg/mL by sonicating for 10 minutes. The upper surface and the lower surface of the carbon nanotube composite porous membranes prepared in Embodiment 1 are coated with 100 μL of the photothermal and electrothermal responsive carbolong complex 3# with the concentration of 2 mg/mL.

Step (2), the carbon nanotube composite porous membranes modified with the photothermal and electrothermal responsive carbolong complex 3# prepared in step (1) is used, and the interdigital electrode in FIG. 3 is connected to the carbon nanotube composite porous membranes (connection parts of the interdigital electrode can be omitted in this step). A sandwich package structure comprising a first PMMA package clip, a first silica gel pad package clip, the interdigital electrode bonded with the carbon nanotube composite porous membranes, a second silica gel pad package clip, and a second PMMA package clip is used to package the interdigital electrode. Four of the carbon nanotube composite porous membranes modified with the photothermal and electrothermal responsive carbolong complex 3# are integrated and are then put into the seawater desalination device in FIG. 4, and a heavy brine (100 g/L of NaCl) is injected into the seawater desalination device.

Step (3), a solar simulator is used, power densities of the solar simulator are respectively set to 2 kW/m², 4 kW/m², 6 kW/m², and 8 kW/m². That is, simulated optical concentration Cₒₚₜ corresponds to 2, 4, 6, and 8 times the sunlight intensity. After a light radiation test for 30 minutes, desalination rates of the seawater desalination device are respectively 1.54 kg/m²·h, 10.43 kg/m²·h, 12.73 kg/m²·h, and 15.80 kg/m²·h, mass flow rates of the system are respectively 0.15 g/h, 1.04 g/h, 1.27 g/h, and 1.38 g/h, and energy utilization efficiencies of the system are respectively 27.61%, 93.64%, 76.15%, and 70.91%. When the simulated optical concentration Cₒₚₜ=8, a temperature of a top of the seawater desalination device is highest, and a highest temperature is 65.7° C. Referring to FIG. 6E, a desalination rate in the test is >99%.

### Embodiment 8

Step (1), 4 mg of a powder of photothermal and electrothermal responsive carbolong complex 1# is weighed. The photothermal and electrothermal responsive carbolong complex 1# is an osmium-based complex, and a molecular formula of the photothermal and electrothermal responsive carbolong complex 1# is illustrated in FIG. 10. The photothermal and electrothermal responsive carbolong complex 1# is dissolved in 2 mL of ethanol and mixed to obtain a solution of the photothermal and electrothermal responsive carbolong complex 1# with a concentration of 2 mg/mL by sonicating for 10 minutes. The upper surface and the lower surface of the carbon nanotube composite porous membranes prepared in Embodiment 1 are coated with 100 μL of the photothermal and electrothermal responsive carbolong complex 1# with the concentration of 2 mg/mL.

Step (2), the carbon nanotube composite porous membranes modified with the photothermal and electrothermal responsive carbolong complex 1# prepared in step (1) are used. Referring to FIG. 3, the interdigital electrode in FIG. 3 is connected to the carbon nanotube composite porous membranes, and a sandwich package structure comprising a first PMMA package clip, a first silica gel pad package clip, the interdigital electrode bonded with the carbon nanotube composite porous membranes, a second silica gel pad package clip, and a second PMMA package clip is used to package the interdigital electrode. Four of the carbon nanotube composite porous membranes modified with the photothermal and electrothermal responsive carbolong complex 1# are integrated and are then put into the seawater desalination device in FIG. 4, and a heavy brine (100 g/L of NaCl) is injected into the seawater desalination device.

Step (3), referring to an electrothermal-photothermal 24 hour continuous seawater desalination device in FIG. 2, a solar panel in the system can store part of solar energy in a form of electrical energy under daylight conditions. On the other hand, the carbon nanotube composite porous membranes in the seawater desalination device can directly absorb energy in sunlight, and a photothermal conversation is complete. This heat promotes water molecules to evaporate and pass through micrometer-nanometer composite pores of the carbon nanotube composite porous membranes modified with the photothermal and electrothermal responsive carbolong complex 1#, while inorganic salt ions in large-sizes are retained by the carbon nanotube composite porous membranes modified with the photothermal and electrothermal responsive carbolong complex 1#. The evaporated water molecules are collected, and the solar seawater desalination is finally achieved. An evaporation rate is 10.43 kg/m²·h, and a salt rejection rate is >99%. The solar panel in the system can release the electric energy stored under the daylight conditions at night, and a voltage is 26.4V. The solar panel is connected to the titanium electrode introduced from the electrode holes 11 and

60. A surface of the carbon nanotube composite porous membranes generates Joule heat under an action of electric current. The carbon nanotube composite porous membranes can also achieve electro-induced seawater desalination due to the Joule heat. A maximum of an evaporation rate of the seawater desalination device is up to 26.7 kg/m²·h, and a salt rejection rate is >99%. As a result, a 24 hour continuous seawater desalination is achieved. When a voltage is 15 V, an electrochemical corrosion is less. An evaporation rate of the seawater desalination device is 12.51±0.08 kg/m²·h under the action of the electric current. A maximum of a salt rejection rate of the seawater desalination device is up to 10.61±0.17 kg/m²·h under optimal conditions (Cₒₚₜ=4), and an average desalination rate in 24 hours is 11.56±0.13 kg/m²·h under this condition.

### Embodiment 9

Step (1), 4 mg of a powder of a photothermal and electrothermal responsive carbolong complex 5# is weighted. The photothermal and electrothermal responsive carbolong complex 5# is an osmium-based polycarbolong polymer. A molecular formula of the photothermal and electrothermal responsive carbolong complex 5# is illustrated in FIG. 10. The photothermal and electrothermal responsive carbolong complex 5# is dissolved in 2 mL of ethanol and is mixed to obtain a solution of the photothermal and electrothermal responsive carbolong complex 5# with a concentration of 2 mg/mL by sonicating for 10 minutes. The carbon nanotube composite porous membranes prepared in Embodiment 1 are used, and an upper surface and a lower surface of the carbon nanotube composite porous membranes are respectively coated with 100 μL of the photothermal and electrothermal responsive carbolong complex 5# with the concentration of 2 mg/mL.

Step (2), the carbon nanotube composite porous membranes modified with the photothermal and electrothermal responsive carbolong complex 5# prepared in step (1) are used. Referring to FIG. 3, the interdigital electrode in FIG. 3 is used to connect the carbon nanotube composite porous membranes modified with the photothermal and electrothermal responsive carbolong complex 5#, and a sandwich package structure comprising a first PMMA package clip, a first silica gel pad package clip, the interdigital electrode bonded with the carbon nanotube composite porous membranes modified with the photothermal and electrothermal responsive carbolong complex 5#, a second silica gel pad package clip, and a second PMMA package clip is used to package the interdigital electrode. Four of the carbon nanotube composite porous membranes modified with photothermal and electrothermal responsive carbolong complex 5# are integrated and are then put into the seawater desalination device in FIG. 4, and seawater (which is sampled from a sea area in Xiamen, a concentration of Cl⁻ is 19.4 g/L) is injected into the seawater desalination device.

Step (3), referring to the Joule heat-photothermal 24 hour continuous seawater desalination device in FIG. 2, a solar panel in the system can store part of solar energy in a form of electrical energy under light conditions. On the other hand, the carbon nanotube composite porous membranes modified with the photothermal and electrothermal responsive carbolong complex 5# can directly absorb energy in sunlight, and a photothermal conversation is complete. This heat promotes water molecules evaporate and pass through micrometer-nanometer composite pores of the carbon nanotube composite porous membranes modified with the photothermal and electrothermal responsive carbolong complex 5#, while inorganic salt ions in large sizes are retained by the carbon nanotube composite porous membranes modified with photothermal and electrothermal responsive carbolong complex 5#. The evaporated water molecules are collected, and a solar seawater desalination is finally achieved. When a light radiation intensity is 1 kW/m², that is, when Cₒₚₜ=1, an evaporation rate of the seawater desalination device in which the carbon nanotube composite porous membranes coated with the photothermal and electrothermal responsive carbolong complex 5# is higher. A value of the evaporation rate is 2.41 kg/m²·h, and a desalination rate is >99%. The solar panel in the system can release the electric energy stored under the daylight conditions at night, a voltage is 15 V, and the solar panel is connected to the interdigital electrode introduced from the electrode holes 11 and 60. A surface of the carbon nanotube composite porous membranes coated with the photothermal and electrothermal responsive carbolong complex 5# generates Joule heat under electric current. The carbon nanotube composite porous membranes coated with the photothermal and electrothermal responsive carbolong complex 5# can also achieve electro-induced seawater desalination under the Joule heat. An evaporation rate of the seawater desalination device is 12.98 kg/m²·h, and a concentration of Cl⁻ after seawater desalination is 2.71 g/L.

What is claimed is:

1. A device for continuous seawater desalination, comprising:
a carbon-based composite membrane unit,
a power supply unit, and
a freshwater collection unit, wherein:
the carbon-based composite membrane unit comprises one or more carbon nanotube composite porous membranes,
the one or more carbon nanotube composite porous membranes are one or more hydrophobic carbon nanotube composite membranes with a micrometer-nanometer multi-level pore structure prepared by perforating the one or more hydrophobic carbon nanotube composite membranes made of carbon-based material composite hydrophobic polymer,
the power supply unit comprises a solar panel that provides electrical energy for the carbon-based composite membrane unit,
the freshwater collection unit collects fresh water treated by the carbon-based composite membrane unit,
the carbon-based composite membrane unit performs photothermal conversion to provide first heat and a first driving force for a first mass transmission to complete a photothermal seawater desalination process under daylight conditions,
the solar panel of the power supply unit is used to store light energy in a form of electric energy under the daylight conditions,
the electric energy stored in the solar panel provides power to the carbon-based composite membrane unit to enable the carbon-based composite membrane unit to generate Joule heat to provide a second heat and a second driving force for a second mass transmission to complete an electrothermal seawater desalination process under insufficient daylight conditions or night conditions, and
the photothermal seawater desalination process and the electrothermal seawater desalination process are repeated to achieve the continuous seawater desalination by uninterruptedly alternating a photothermal process and an electrothermal process.

2. The device for the continuous seawater desalination according to claim 1, wherein:
a surface of the one or more hydrophobic carbon nanotube composite membranes made of the carbon-based material composite hydrophobic polymer is coated with a photothermal and electrothermal responsive carbolong complex.

3. The device for the continuous seawater desalination according to claim 1, wherein:
a perforated area of each of the one or more hydrophobic carbon nanotube composite membranes is 5 mm×5 mm and comprises 30 pores-100 pores, and
pore diameters of all the pores are 50 μm-120 μm.

4. The device for the continuous seawater desalination according to claim 1, wherein:
the one or more carbon nanotube composite porous membranes are connected to an electrode, and
a sandwich package structure is used to package the one or more carbon nanotube composite porous membranes and the electrode.

5. The device for the continuous seawater desalination according to claim 4, wherein:
a first polymethyl methacrylate plate, a first silica gel, the one or more carbon nanotube composite porous membranes connected to the electrode, a second silica gel, and a second polymethyl methacrylate plate are superimposed in sequence to define the sandwich package structure.

6. The device for the continuous seawater desalination according to claim 4, wherein:
a connection structure of the electrode comprises a positive pole of a titanium electrode, a negative pole of the titanium electrode, a screw hole, a location area for the one or more carbon nanotube composite porous membranes, and the one or more carbon nanotube composite porous membranes,
an upper edge and a lower edge of each of the one or more carbon nanotube composite porous membranes to be respectively bonded to an upper edge and a lower edge of a corresponding one of interdigital parts of the positive pole and the negative pole of the titanium electrode by using conductive silver glue, and
a left edge and a right edge of each of the one or more carbon nanotube composite porous membranes are not bonded to the positive pole and the negative pole of the titanium electrode.

7. The device for the continuous seawater desalination according to claim 4, comprising:
a housing, and
a top cover, wherein:
a bottom of the housing comprises a seawater storage tank,
the one or more carbon nanotube composite porous membranes and the electrode packaged by the sandwich package structure are disposed on the seawater storage tank,
the one or more carbon nanotube composite porous membranes are in contact with seawater,
after the one or more carbon nanotube composite porous membranes generate heat:
the heat enables a phase change of seawater,
evaporated water molecules reach an inner surface of the top cover through the micrometer-nanometer multi-level pore structure in the one or more carbon nanotube composite porous membranes, and
the fresh water, after cold condensation, finally converges into a fresh water collection tank along a slope of the inner surface of the top cover and is led out from a fresh water outlet to complete the continuous seawater desalination.

8. A method for continuous seawater desalination, comprising:
performing photothermal conversion by a carbon nanotube composite porous membrane to provide first heat and a first driving force for a first mass transmission to complete a photothermal seawater desalination process under daylight conditions,
using a solar panel to store light energy in a form of electric energy under the daylight conditions,
providing the electric energy stored by the solar panel to enable a carbon-based composite membrane unit comprising the carbon nanotube composite porous membrane to generate Joule heat to provide a second heat and a second driving force for a second mass transmission to complete an electrothermal seawater desalination process under insufficient daylight conditions or night conditions, and
repeating the photothermal seawater desalination process and the electrothermal seawater desalination process to achieve 24 hour continuous seawater desalination by alternating a photothermal process and an electrothermal process.

9. The method for the continuous seawater desalination according to claim 8, wherein a voltage of a direct current applied by the solar panel is 5 V-30 V.

10. The method for the continuous seawater desalination according to claim 8, comprising:
performing the method in a device for the continuous seawater desalination, wherein:
the device for the continuous seawater desalination comprises a carbon-based composite membrane unit, a power supply unit, and a freshwater collection unit,
the carbon-based composite membrane unit comprises one or more carbon nanotube composite porous membranes,
the one or more carbon nanotube composite porous membranes are one or more hydrophobic carbon nanotube composite membranes with a micrometer-nanometer multi-level pore structure prepared by perforating the one or more hydrophobic carbon nanotube composite membranes made of carbon-based material composite hydrophobic polymer,
the power supply unit comprises a solar panel that provides electrical energy for the carbon-based composite membrane unit,
the freshwater collection unit collects fresh water treated by the carbon-based composite membrane unit,
the carbon-based composite membrane unit performs photothermal conversion to provide a first heat and a first driving force for a mass transmission to complete a photothermal seawater desalination process under daylight conditions,
the solar panel of the power supply unit is used to store light energy in a form of electric energy under the daylight conditions,
the electric energy stored in the solar panel provides power to the carbon-based composite membrane unit to enable the carbon-based composite membrane unit to generate Joule heat to provide a second heat and a second driving force for a second mass transmission to complete an electrothermal seawater desalination process under insufficient daylight conditions or night conditions, and
the photothermal seawater desalination process and the electrothermal seawater desalination process are repeated to achieve the continuous seawater desalination by uninterruptedly alternating a photothermal process and an electrothermal process.

11. A device for seawater continuous desalination, comprising:
a carbon-based composite membrane unit,
a power supply unit, and
a freshwater collection unit, wherein:
the carbon-based composite membrane unit comprises one or more carbon nanotube composite porous membranes,
the one or more carbon nanotube composite porous membranes are one or more hydrophobic carbon nanotube composite membranes with a micrometer-nanometer multi-level pore structure prepared by perforating the one or more hydrophobic carbon nanotube composite membranes made of carbon-based material composite hydrophobic polymer,
the power supply unit comprises a solar panel, the one or more carbon nanotube composite porous membranes are connected to a positive pole and a negative pole of the power supply unit to provide electrical energy for the carbon-based composite membrane unit, and
the freshwater collection unit collects fresh water treated by the carbon-based composite membrane unit.

12. The device for the continuous seawater desalination according to claim 11, wherein:
the one or more carbon nanotube composite porous membranes are connected to an electrode, and
a sandwich structure is used to package the one or more carbon nanotube composite porous membranes and the electrode.

13. The device for the continuous seawater desalination according to claim 12, wherein:
one of the one or more carbon nanotube composite porous membranes is connected to a positive pole and a negative pole of the electrode, or
more than one of the one or more carbon nanotube composite porous membranes are connected to a positive pole and a negative pole of the electrode in parallel.

14. The device for the continuous seawater desalination according to claim 11, wherein:
the one or more carbon nanotube composite porous membranes are 30 pores-100 pores per 5 mm×5 mm, and
pore diameters of the pores are 50 μm-120 μm.

15. The device for the continuous seawater desalination according to claim 11, wherein surfaces of the one or more carbon nanotube composite porous membranes are coated with a photothermal and electrothermal responsive metal complex.
